(19) United States
(12) Patent Application Publication
(10) Pub. No.: US 2003/0051980 A1
(43) Pub. Date: Mar. 20, 2003

(54) Press device having separably removable transfer bars

(76) Inventor: Hugh Sofy, Troy, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 09/952,065

(22) Filed: Sep. 14, 2001

(51) Int. Cl. B65G 25/02

(52) U.S. Cl. 198/621.1; 72/405.11; 72/405.13

(57) ABSTRACT

A work piece transfer assembly (10) for moving a work piece (12) through and between presses comprises a transfer mechanism (14) moveable in a longitudinal (60), a lateral (62), and a vertical direction (64) and having a first end (16) and a second end (18) for supporting at least one main transfer bar (20). The main transfer bar (20) has a predetermined length (22) with a support mechanism (24) attached thereto for supporting a sub-transfer bar (26). The sub-transfer bar (26) includes a plurality of fingers (28) extending from the sub-transfer bar (26) for engaging and moving the work piece (12) between the presses. The support mechanism (24) includes a cradle (30) fixedly attached to the transfer bars (20). The cradle (30) also includes an alignment sub-assembly (38) for securing the sub-transfer bar (26) into the cradle (30) and precisely aligns said sub-transfer bar upon each re-attachment of the sub-transfer bar (26) to the cradle (30).

### BACKGROUND OF THE INVENTION

1. Field of the Invention

A work piece transfer assembly for moving a work piece through and between presses.

2. Description of the Prior Art

Various work piece transfer assemblies for moving a work piece through and between presses are known in the prior art. All of these assemblies comprise a main transfer bar having a predetermined length. Most of the prior art assemblies have the main transfer bar having individual fingers attached directly thereto. The fingers are individually aligned and positioned to engage the work piece. Other assemblies have the main transfer bar supporting a sub-transfer bar. The fingers are then individually attached to the sub-transfer bar and positioned for engaging the work piece.

An assembly having a main transfer bar with individual fingers is shown in U.S. Pat. Nos. 5,680,787 and 5,899,109 to Fisch. The '787 patent and the '109 patent discloses a transfer assembly having a main transfer bar with a plurality of fingers extending therefrom for moving work pieces. The main transfer bar is supported by an arm which is secured by a clamp. The clamp can be loosened and the length of the arm can be changed. By changing the length of the arm, the same main transfer bar can be used to handle differently sized work pieces. These prior art assemblies are limited in accommodating larger work pieces by the distance between the transfer assemblies and may therefore be non-advantageous for larger presses and work pieces.

Another assembly having a main transfer bar with a plurality of sub-transfer bars having individual fingers is disclosed in U.S. Pat. No. 5,771,561 to Hofele. The '561 patent has the sub-transfer being separably removable from the main transfer bar. In order for the sub-transfer bar to be removed, an automatic receiving device must engage the sub-transfer bar. Then, the main transfer bar is moved laterally and vertically which disengages the sub-transfer bar. This operation must be performed for each of the sub-transfer bars engaging the main transfer bar, thereby consuming considerable amounts of time that the presses are not operating.

It would be advantageous to provide an assembly having a seperably removable sub-transfer bar that allows for quick removal and change over of entire sub-transfer bars. Additionally, the prior art assemblies require additional time to ensure that the sub-transfer bars are precisely aligned each time they are reattached to the main transfer bar. The prior art assemblies are inefficient when work pieces and presses must be changed frequently and are limited in their ability to service different work pieces or presses.

### SUMMARY OF THE INVENTION AND ADVANTAGES

The subject invention provides a work piece transfer assembly for moving a work piece through and between presses. The work piece transfer assembly includes at least two main transfer bars having a predetermined length and at least one sub-transfer bar in parallel relationship to the main transfer bar and having a plurality of fingers extending from the sub-transfer bar for engaging and moving the work piece. A plurality of support mechanisms are fixedly attached to the main transfer bar and include an upwardly opening cradle for interconnecting the main transfer bar and the sub-transfer bar. A pin is inserted through the cradle and the sub-transfer bar for securing the sub-transfer bar into the cradle such that the pin is removable to allow the sub-transfer bar to be removed from the cradle. The assembly is characterized by having an alignment sub-assembly supported by the sub-transfer bar and the cradle and engaging the pin for precisely aligning the sub-transfer bar relative to the main transfer bar to position the plurality of fingers in the same position relative to the main transfer bar upon each re-attachment of the sub-transfer bar to the cradle.

Accordingly, the subject invention allows the sub-transfer bars to be quickly and efficiently reattached to the main transfer bar. The alignment subassembly ensures precise alignment every time the sub-transfer bar is re-attached in a minimal amount of time, thereby making the subject invention practical for handling differently sized work pieces. Once the work piece or press is changed, the sub-transfer bar can quickly be removed and replaced with a corresponding sub-transfer bar for the specific work piece or press.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a side view of a work piece transfer assembly illustrating a main transfer bar connected to a support mechanism fixedly attached thereto having a cradle for supporting a sub-transfer bar;

FIG. 2 is a top view of the assembly having a plurality of fingers engaging a work piece;

FIG. 3 is a perspective view of the assembly having a sub-transfer bar;

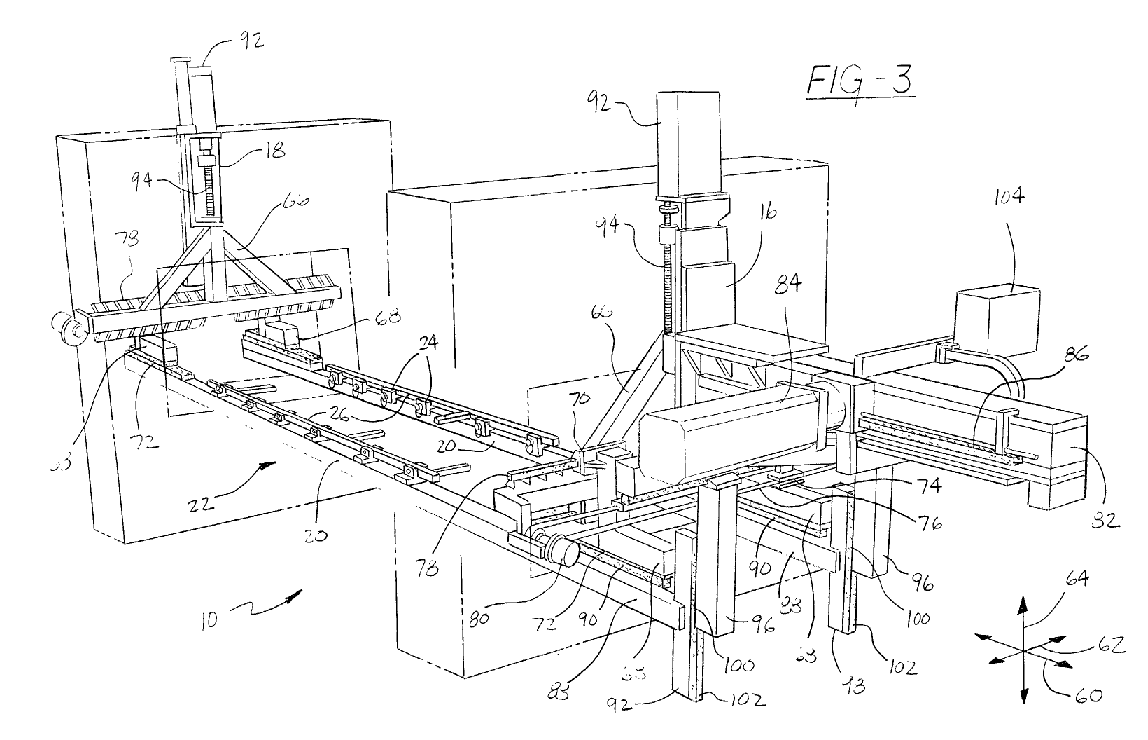

FIG. 4 is a side view of another embodiment of the work piece transfer assembly having an extension interconnecting the main transfer bar and the cradle of the support mechanism; and

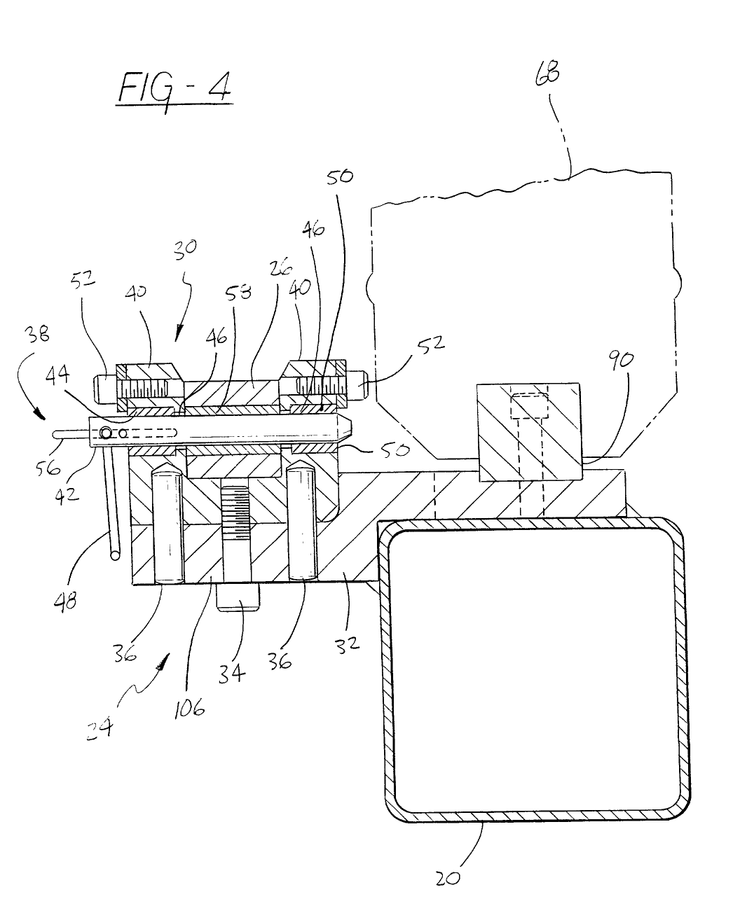

FIG. 5 is a perspective view of the assembly having a plurality of sub-transfer bars.

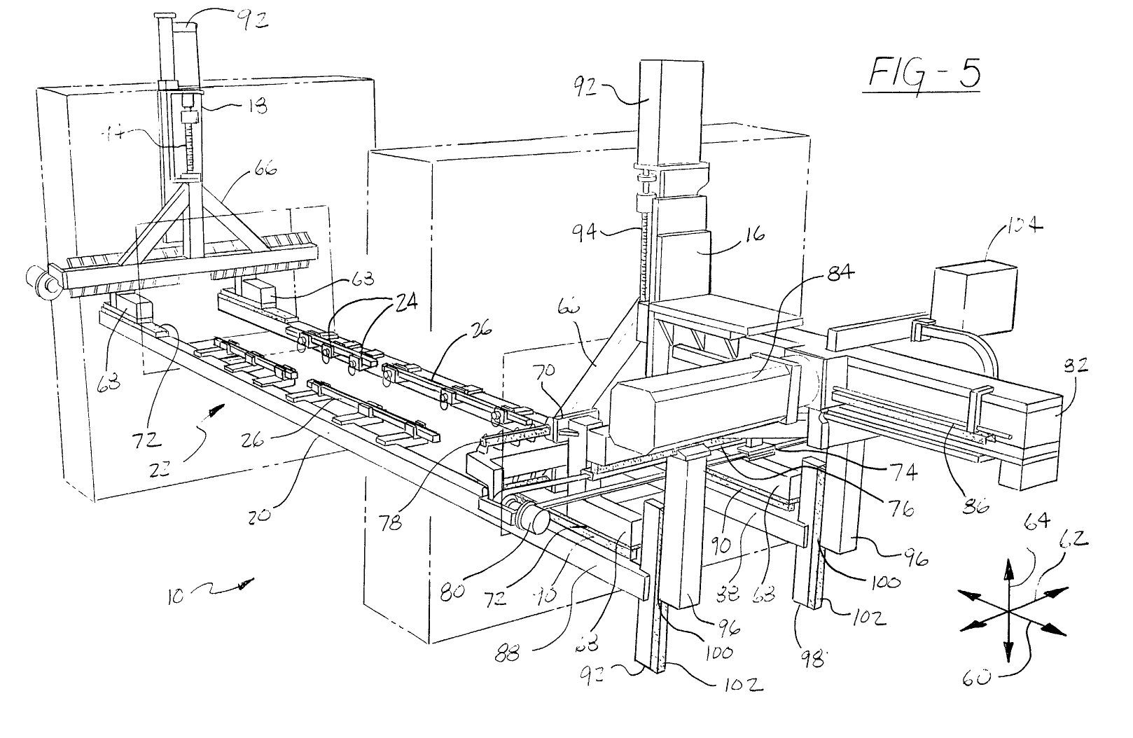

### DETAILED DESCRIPTION OF THE PREFERRED EMBODIMENT

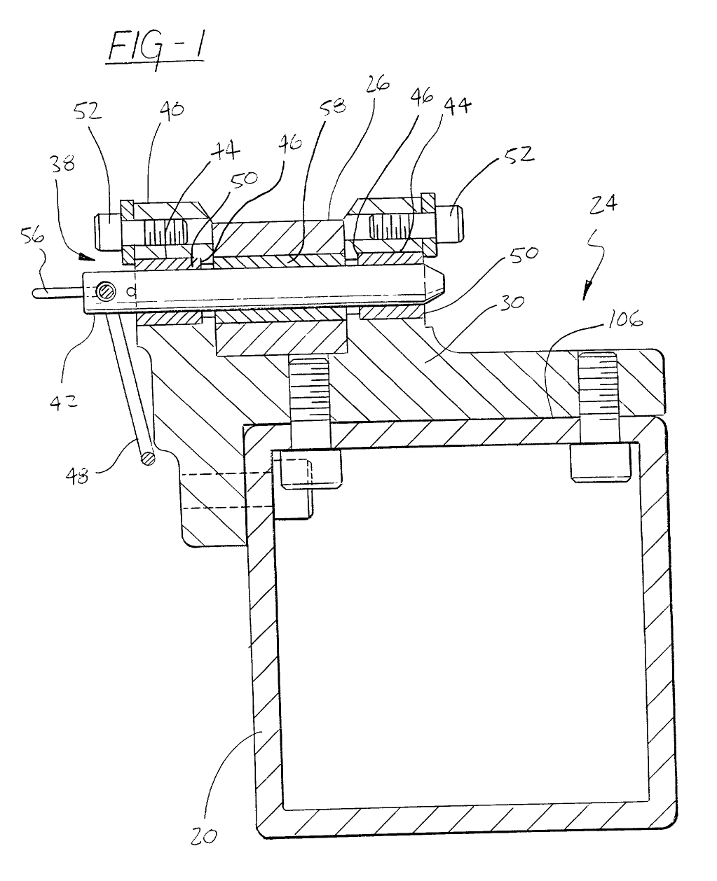

Referring to the Figures, wherein like numerals indicate like or corresponding parts throughout the several views, a work piece transfer assembly 10 for moving a work piece 12 through and between presses (not shown) is shown in FIG. 1. The work piece transfer assembly 10 is described below as being used on a particular press, however, the assembly 10 could be used with other types of presses than that described. The presses used may include any typical presses used for forming work pieces as known to one skilled in the art. Multiple presses are typically positioned within the transfer assembly 10 such that the transfer assembly 10 moves the work piece successively between the adjacent presses. The transfer assembly 10 may also be utilized in a series of the transfer assemblies 10 and therefore would move the work piece through multiple assemblies.

The assembly 10 comprises a transfer mechanism 14 having a first end 16 and a second end 18 for supporting at least two main transfer bar 20. In the preferred embodiment, the transfer mechanism 14 supports two main transfer bars 20. However, the subject invention description, for clarity, is focused on describing only one main transfer bar 20. The main transfer bar 20 has a predetermined length 22 with a support mechanism 24 attached thereto for supporting at lease one sub-transfer bar 26. The sub-transfer bar 26 includes a plurality of fingers 28 extending from the sub-transfer bar 26 for engaging and moving the work piece 12 between the presses. The sub-transfer bar 26 preferably extends the entire predetermined length 22. However, a plurality of sub-transfer bars 26 may be disposed in series along the predetermined length 22 of the main transfer bar 20. The sub-transfer bars 26 are in end to end relationship with one another.

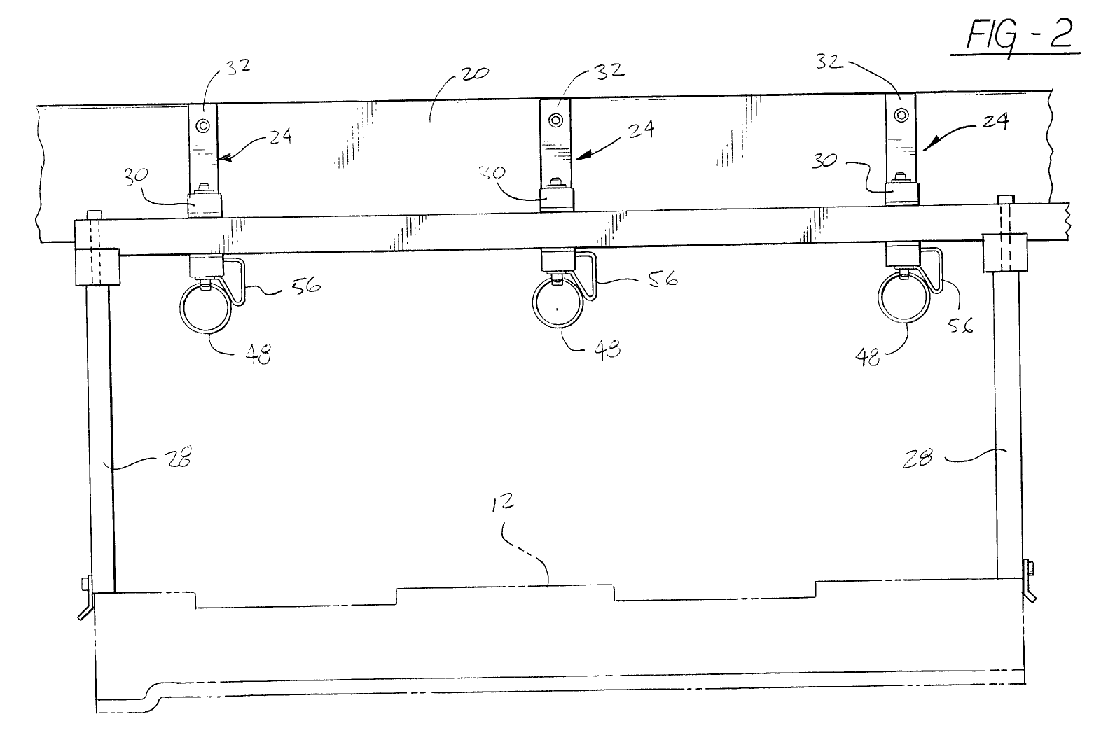

The sub-transfer bar 26 is supported by at least one support mechanism 24 along the length of the sub-transfer bar 26. Preferably, at least two support mechanisms 24 support the length of the sub-transfer bar 26. Even more preferably, the sub-transfer bar 26 is supported every forty inches with the support mechanism 24. However, it is to be understood that the support mechanism 24 could be positioned differently than described to carry out the subject invention. The support mechanism 24 includes a cradle 30 which is upwardly opening and has two arms 40 extending from a base 106. The cradle 30, as shown in FIG. 1, is fixedly attached to the main transfer bar 20. The main transfer bar 20 has openings to allow bolts be inserted through the main transfer bar 20. The bolts engage the support mechanism 24 for supporting the sub-transfer bar 26. Alternately, FIG. 2 shows an extension 32 interconnecting the cradle 30 and the main transfer bar 20. The extension 32 includes a threaded connector 34 and at least one support 36 for securing the cradle 30 to the extension 32 and preventing rotation of the cradle 30. The threaded connector 34 is inserted through the extension 32 and engages the base 106 of the cradle 30. The supports 36 also engage the base 106 of the cradle 30 to prevent rotation of the cradle 30 about the extensions 32.

The assembly 10 also includes a pin 42 inserted through the cradle 30 and extending through the sub-transfer bar 26. The pin 42 includes a ring 48 which allows for easy manipulation of the pin 42. Once the sub-transfer bar 26 is seated in the cradle 30, the pin 42 is inserted. The pin 42 secures the sub-transfer bar 26 into the cradle 30 and prevents the sub-transfer bar 26 from dislodging. The pin 42 can be quickly removed from the cradle 30, and the sub-transfer bar 26 removed. For accommodating differently sized work pieces, additional sub-transfer bars may be reinserted into the cradle 30 and secured with the pin 42.

Preferably, the sub-transfer bar 26 is an aluminum bar allowing for a lightweight sub-transfer bar 26 that can be easily removed. The sub-transfer bar 26 is more preferably a one and a quarter inch square aluminum bar. However, a different material, such as plastic, having any shape or any size may be utilized with the subject invention. The main transfer bar 20 is also preferably an aluminum bar. However, the main transfer bar 20 must be larger in size to give support to the sub-transfer bar 26. Therefore, the main transfer bar 20 is more preferably a four inch square aluminum tube. Since the main transfer bar 20 is required for support and the predetermined length 22 can be quite long, the main transfer bar 20 is too heavy to be removed and changed frequently for different work pieces. However, the main transfer bar 20 could utilize a different material and be any shape or size to accomplish the subject invention.

The assembly 10 is characterized by having an alignment subassembly 38 supported by the sub-transfer bar 26 and the cradle 30 and engaging the pin 42 for precisely aligning the sub-transfer bar 26 relative to the main transfer bar 20 to position the plurality of fingers 28 in the same position relative to the main transfer bar 20 upon each re-attachment of the sub-transfer bar 26 to the cradle 30. The alignment sub-assembly 38 is preferably a material which will not become deformed, such as steel. If the alignment sub-assembly 38 was a softer material than the pin 42 or if there was no alignment sub-assembly 38, the sub-transfer bar 26 would become deformed and would not be precisely aligned to engage the work piece. Each time the sub-transfer bar 26 is removed and reattached, the fingers 28 must be precisely aligned to engage the work piece. In order for operators of the assembly 10 to be efficient, significant amount of time must not be spent realigning the sub-transfer bar 26 and the fingers 28. The alignment sub-assembly 38 ensures that each and every time the sub-transfer bar 26 is re-attached, the sub-transfer bar 26 and the fingers 28 will be precisely aligned.

The alignment sub-assembly 38 includes a sub-transfer bar bushing 58 having an opening and being disposed within the sub-transfer bar 26 for receiving the pin 42. The alignment sub-assembly 38 further includes at least one cradle bushing 50 having an opening and being disposed within the cradle 30 for receiving the pin 42. The sub-transfer bar bushing 58 and cradle bushing 50 may be any guide known to one skilled in the art. Each of the arms 40 of the cradle 30 includes a counter bore 44 having a bottom 46. The bushing 50 is inserted into the counter bore 46. The alignment sub-assembly 38 further comprises at least one cradle bushing retainer 52 for securing the cradle bushing 50 in the cradle 30. The cradle bushing retainer 52 may be a screw, as shown in FIG. 1, inserted into each of the arms 40 for securing the cradle bushings 50 into the cradle 30. The pin 42 engages the cradle bushing 50 once the pin 42 is inserted into the cradle 30.

The cradle 30 also has a lock 54 connected to one of the arms 40 of the cradle 30. The lock 54 can be integrally formed or physically connected to the cradle 30. The pin 42 further includes a locking clip 56 that engages the lock 54 for preventing the pin 42 from dislodging from the cradle 30. The lock 54 may be a cavity for receiving one end of the locking clip 56. Once the sub-transfer bar 26 is seated in the cradle 30, the pin 42 is inserted through the counter bore 44 and the locking clip 56 is inserted into the lock 54. Once the locking clip 56 is in the lock 54, the sub-transfer bar is prevented 26 from dislodging from the cradle 30. However, the lock 54 and the locking clip 56 may include other locking means as is known to one skilled in the art of securing a bar within a cradle.

In the preferred embodiment, two main transfer bars 20 are supported by the transfer mechanism 14. However, it is to be understood that the transfer mechanism 14 may be different than described and still carry out the subject invention. Other transfer mechanism are known in the art for moving work pieces through presses. The transfer mechanism 14 is able to move the main transfer bar 20 in a longitudinal 60, a lateral 62, and a vertical direction 64. The movement of the main transfer bars 20 moves the work piece 12 through and between the presses. The first end 16 and the second end 18 include a first support 66 connected to at least one first leg 68. The first leg is shown as being shaped like an “L”. The first leg 68 includes at least one first receiving channel 70 and at least one second receiving channel 72. A clamp 74 is connected to the first leg 68 and engages a belt 76. The first support 66 further includes at least one lateral linear motion rail (LMR) 78 attached to the first support 66 for movement by and with the clamp 74. The first end 16 and the second end 18 include a first motor 80 attached to the first support 66. The first receiving channel 70 of the first leg 68 engages the lateral LMR 78 of the first support 66. The motor operatively engages the belt 76 connected to the first leg 68, such that when the motor is operated, the belt 76 is rotated moving the clamp 74 and causing the first leg 68 to laterally move along the first support 66.

A second support 82 is connected to the first end 16 for moving the main transfer bar 20 in the longitudinal direction 60. The second support 82 comprises a second motor 84 and at least one first longitudinal LMR 86. The second support 82 is in engagement with the first longitudinal LMR 86. A second leg 88 is supported by the second support 82 and has a second longitudinal LMR 90. The second leg 88 is also connected to the main transfer bar 20. The second longitudinal LMR 90 is in engagement with the second receiving channel 72 of the first leg 68. When the second motor 84 is operated, the second support 82 moves along the first longitudinal LMR 86. The movement of the second support 82 causes the second leg 88 to move longitudinally through the second receiving channel 72 of the first leg 68. The movement of the second leg 88 causes the main transfer bar 20 to move in the longitudinal direction 60.

The first end 16 and the second end 18 each includes a third motor 92 and a ball screw 94 connected to the first support 66 for moving the first support 66 in the vertical direction 64. The motor causes the ball screw 94 to move vertically such that the first support 66 also moves vertically. When the first support 66 moves vertically, the first leg 68, which is attached to the first support 66, moves vertically. The first end 16 includes a third leg 96 and a fourth leg 98 for providing a vertical slip plane connection to the longitudinal drive means. The third leg 96 is connected to the second support 82 and has a third receiving channel 100. The fourth leg 98 is connected to the first support 66 and has a vertical LMR 102 such that the third receiving channel 100 engages the vertical LMR 102. When the first support 66 is moved vertically, the fourth leg 98 moves vertically within the third receiving channel 100 of the third leg 96. The second end 18 does not have a second support 82 and does not require the third or fourth leg 98.

The transfer mechanism 14 is connected to a controller 104 for controlling operation of the motors. The controller 104 can be programmed to accommodate differently sized presses or work pieces by limiting the amount of movement in the three directions. In the preferred embodiment, the controller 104 is fixedly attached to the transfer mechanism 14. However, the controller 104 could be housed apart and separate from the transfer mechanism 14 and control more then one transfer mechanism concurrently.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A work piece transfer assembly for moving multiple work pieces through and between presses, said assembly comprising:
at least two main transfer bars (20) having a predetermined length (22);
at least one sub-transfer bar (26) in parallel relationship to said main transfer bar (20) and having a plurality of fingers (28) extending from said sub-transfer bar (26) for engaging and moving the work piece;
a plurality of support mechanisms (24) fixedly attached to said main transfer bar (20) including an upwardly opening cradle (30) interconnecting said main transfer bar (20) and said sub-transfer bar (26);
a pin (42) inserted through said cradle (30) and said sub-transfer bar (26) for securing said sub-transfer bar (26) into said cradle (30) such that said pin (42) is removable to allow said sub-transfer bar (26) to be removed from said cradle (30);
said assembly characterized by having an alignment sub-assembly (38) supported by said sub-transfer bar (26) and said cradle (30) and engaging said pin (42) for precisely aligning said sub-transfer bar (26) relative to said main transfer bar (20) to position said plurality of fingers (28) in the same position relative to said main transfer bar (20) upon each re-attachment of said sub-transfer bar (26) to said cradle (30).

2. A work piece transfer assembly as set forth in claim 1 wherein said alignment sub-assembly (38) further comprises a sub-transfer bar bushing (58) having an opening and being disposed within said sub-transfer bar (26) for receiving said pin (42).

3. A work piece transfer assembly as set forth in claim 2 wherein said alignment sub-assembly (38) further comprises at least one cradle bushing (50) having an opening and being disposed within said cradle (30) for receiving said pin (42).

4. A work piece transfer assembly as set forth in claim 3 wherein said alignment sub-assembly (38) further comprises at least one cradle bushing retainer (52) for securing said cradle bushing (50) in said cradle (30).

5. A work piece transfer assembly as set forth in claim 4 wherein said cradle (30) further includes a counter bore (44) having a bottom (46) and said cradle bushing (50) being inserted into said counter bore (44) to engage said bottom (46).

6. A work piece transfer assembly as set forth in claim 1 wherein said pin (42) further includes a locking clip (56) for engaging a lock (54) connected to said cradle (30) for preventing said pin (42) and said sub-transfer bar (26) from dislodging from said cradle (30).

7. A work piece transfer assembly as set forth in claim 1 wherein said plurality of fingers (28) are fixed relative to one another on said sub-transfer bar (26) such that each of said plurality of fingers (28) are positioned to engage said work pieces (12).

8. A work piece transfer assembly as set forth in claim 1 wherein said support mechanism (24) further comprises an extension (32) fixedly attached to said main transfer bar (20) and having a connector (34) and at least one support (36) for securing said cradle (30) to said extension (32) and preventing rotation of said cradle (30).

9. A work piece transfer assembly as set forth in claim 1 including a plurality of said sub-transfer bars (26) disposed in series along said predetermined length (22) of said main transfer bar (20) wherein each of said sub-transfer bars (26) are separably removable from said main transfer bar (20).

10. A work piece transfer assembly as set forth in claim 1 wherein said first end (16) and said second end (18) further include a first support (66) connected to at least one first leg (68), said first leg (68) being moveable in a longitudinal direction (60) and a lateral direction (62).

11. A work piece transfer assembly as set forth in claim 10 wherein said first end (16) and said second end (18) further include a first motor (80) attached to said first support (66), said motor operatively engaging a belt (76) connected to said first leg (68) for moving said main transfer bar (20) in said lateral direction (62).

12. A work piece transfer assembly as set forth in claim 11 wherein said first support (66) further comprises at least one lateral linear motion rail (78).

13. A work piece transfer assembly as set forth in claim 12 wherein said first leg (68) further comprises at least one first receiving channel (70) for engaging said lateral linear motion rail (78).

14. A work piece transfer assembly as set forth in claim 13 wherein said first end (16) further comprises a second support (82) connected to a second motor (84) for moving said carrier (20) in a longitudinal direction (60).

15. A work piece transfer assembly as set forth in claim 14 including at least one first longitudinal linear motion rail (86) connected to said second support (82) for supporting the movement of said main transfer bar (20) in said longitudinal direction (60).

16. A work piece transfer assembly as set forth in claim 15 including a second leg (88) having a second longitudinal linear motion rail (90).

17. A work piece transfer assembly as set forth in claim 16 wherein said first leg (68) further comprises a second receiving channel (72) for engaging said second longitudinal linear motion rail (90).

18. A work piece transfer assembly as set forth in claim 17 including a third leg (96) connected to said second support (82) having a third receiving channel (100).

19. A work piece transfer assembly as set forth in claim 18 including a fourth leg (98) having a vertical linear motion rail (102) such that said third receiving channel (100) engages said vertical linear motion rail (102).

20. A work piece transfer assembly as set forth in claim 19 wherein said first end (16) and said second end (18) further include a third motor (92) and a ball screw (94) connected to said first support (66) for moving said first support (66) in a vertical direction (64).

21. A work piece transfer assembly as set forth in claim 20 including a controller (104) for controlling operation of said motors thereby controlling the movement of said main transfer bars (20) for moving along said predetermined length (22).
